(19) United States
(12) Patent Application Publication
(10) Pub. No.: US 2019/0308901 A1
(43) Pub. Date: Oct. 10, 2019

(54) APPARATUS AND METHOD FOR DYNAMIC THERMAL TEMPERING OF GLASS

(71) Applicant: CORNING INCORPORATED, CORNING, NY (US)

(72) Inventors: Douglas Dale Bressler, Julian, PA (US); Brian Christopher Sheehan, Elmira Heights, NY (US); John Thomas, Elmira, NY (US); Kevin Lee Wasson, Elmira, NY (US)

(21) Appl. No.: 16/464,957

(22) PCT Filed: Dec. 1, 2017
(86) PCT No.: PCT/US2017/064108

§ 371 Date: May 29, 2019

Related U.S. Application Data
(60) Provisional application No. 62/428,532, filed on Dec. 1, 2016.

(51) Int. Cl. C03B 27/048; C03B 27/04; C03B 27/02; C03B 35/24; C03B 35/22

(52) U.S. Cl. CPC C03B 27/048; C03B 27/0413; C03B 35/22; C03B 35/24; C03B 27/02

(57) ABSTRACT

A process for thermally strengthening a glass article comprising first conveying a glass article, having a temperature above a transition point of the glass of the article, into position between two fluid bearing surfaces then moving the fluid bearing surfaces toward the glass article and cooling the glass article, with at least 20% of said cooling taking place by conduction from the glass article to the fluid bearing surfaces. Apparatuses for performing the process and products resulting are also disclosed.

This application claims the benefit of priority under 35 U.S.C. § 119 of U.S. Provisional Application Ser. No. 62/428,532, filed on Dec. 1, 2016, the contents of which are relied upon and incorporated herein by reference in its entirety.

### FIELD

The disclosure relates generally to apparatuses for thermally strengthening glass, defined as including glass and glass ceramics and materials comprising glass, and specifically relates to methods and systems for the thermal tempering glass using dynamic positioning of fluid bearing elements.

### BACKGROUND

In thermal (or “physical”) strengthening of sheets comprising glass (“glass sheets”), a glass sheet is heated to an elevated temperature above the glass transition temperature of the glass and then the surfaces of the sheet are rapidly cooled (“quenched”) while the inner regions of the sheet cool at a slower rate. The inner regions cool more slowly because they are insulated by the thickness and the fairly low thermal conductivity of the glass. The differential cooling produces a residual compressive stress in the sheet surface regions, balanced by a residual tensile stress in the central regions of the sheet.

Thermal strengthening of glass is distinguished from chemical strengthening of glass, in which surface compressive stresses are generated by changing the chemical composition of the glass in regions near the surface by a process such as ion diffusion. In some ion diffusion based processes, exterior portions of glass may be strengthened by exchanging larger ions for smaller ions near the glass surface to impart a compressive stress (also called negative tensile stress) on or near the surface. The compressive stress is believed to limit crack initiation and/or propagation.

Thermal strengthening of glass is distinguished from glass strengthened by processes in which exterior portions of the glass are strengthened or arranged by combining two types of glass. In such processes, layers of glass compositions that have differing coefficients of thermal expansion are combined or laminated together while hot. For example, by sandwiching molten glass with a higher coefficient of thermal expansion (CTE) between layers of molten glass with a lower CTE, positive tension in the interior glass compresses the outer layers when the glasses cool, again forming compressive stress on the surface to balance the positive tensile stress. This surface compressive stress provides strengthening.

Thermally strengthened glass has advantages relative to unstrengthened glass. The surface compression of the strengthened glass provides greater resistance to fracture than unstrengthened glass. The increase in strength generally is proportional to the amount of surface compression stress. If a sheet possesses a sufficient level of thermal strengthening, relative to its thickness, then if the sheet is broken, generally it will divide into small fragments rather than into large or elongated fragments with sharp edges. Glass that breaks into sufficiently small fragments, or “dices,” as defined by various established standards, may be known as safety glass, or “fully tempered” glass, or sometimes simply “tempered” glass.

### SUMMARY

According to embodiments, a process for thermally strengthening a glass article comprises first conveying a glass article, having a temperature above a transition point of the glass of the article, into position between two fluid bearing surfaces, then moving the fluid bearing surfaces toward the glass article and cooling the glass article, with at least 20% of said cooling taking place by conduction from the glass article to the fluid bearing surfaces.

### BRIEF DESCRIPTION OF THE FIGURES

FIG. 1 is an overall isometric perspective view of an embodiment of a system of the present disclosure.

FIG. 2 is a close-up isometric view of a portion of the system of FIG. 1.

FIG. 3 is a close-up cross-sectional isometric view of a portion of the system of FIG. 1.

FIG. 4 is a close-up cross-sectional isometric view of a sliding shaft assembly of the system of FIG. 1.

FIG. 5 is a top orthographic view with hidden lines of the bottom cold bearing and mount of the system of FIG. 1.

FIG. 6 is a top orthographic view of a flat glass preform being conveyed into the cold zone of a system such as the system of FIG. 1, wherein the top and bottom cold fluid bearings have a defined concave and convex, approximately mating three-dimensional shapes, to be imparted into the glass article.

FIG. 7 is an orthographic cross-sectional view of a glass article, positioned between the cold bearings of FIG. 6 when in the closed position, that has been formed into a three-dimensional shape by mating top and bottom cold gas bearings.

FIG. 8 is an orthographic view of a finished glass article that has been formed to have a three-dimensional shape using a method of the present disclosure.

FIG. 9 is a cross sectional diagram of an article within a two-sided fluid bearing.

FIG. 10 is a graph output from a simulation of thermal tempering of glass showing central tension as a function of time to reach final gap size in the cold zone of an embodiment of the present invention.

FIG. 11 is a graph output from a simulation of thermal tempering of glass showing maximum transient surface tension (occurring during cooling at any time) as a function of time to reach final gap size in the cold zone of an embodiment of the present invention.

### DETAILED DESCRIPTION

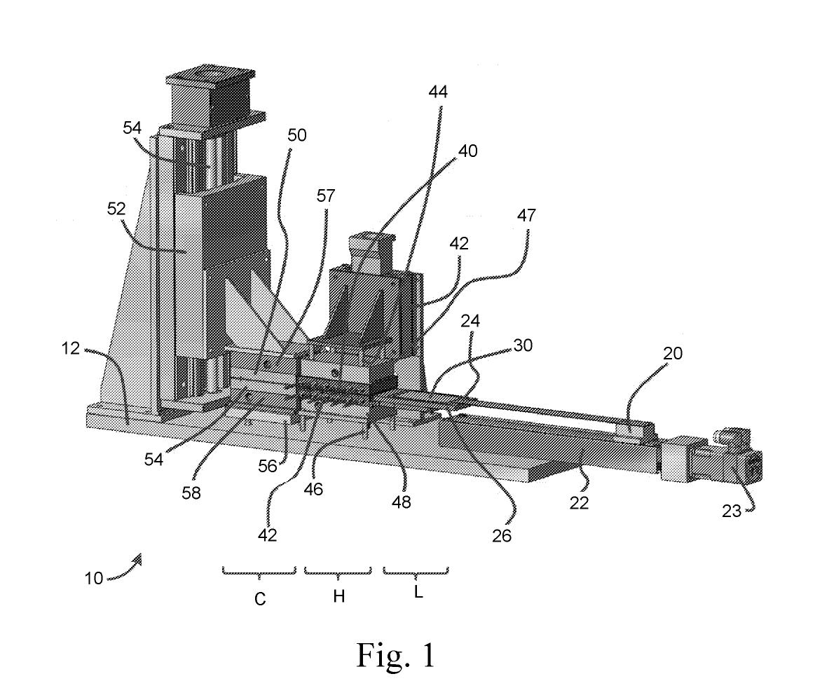

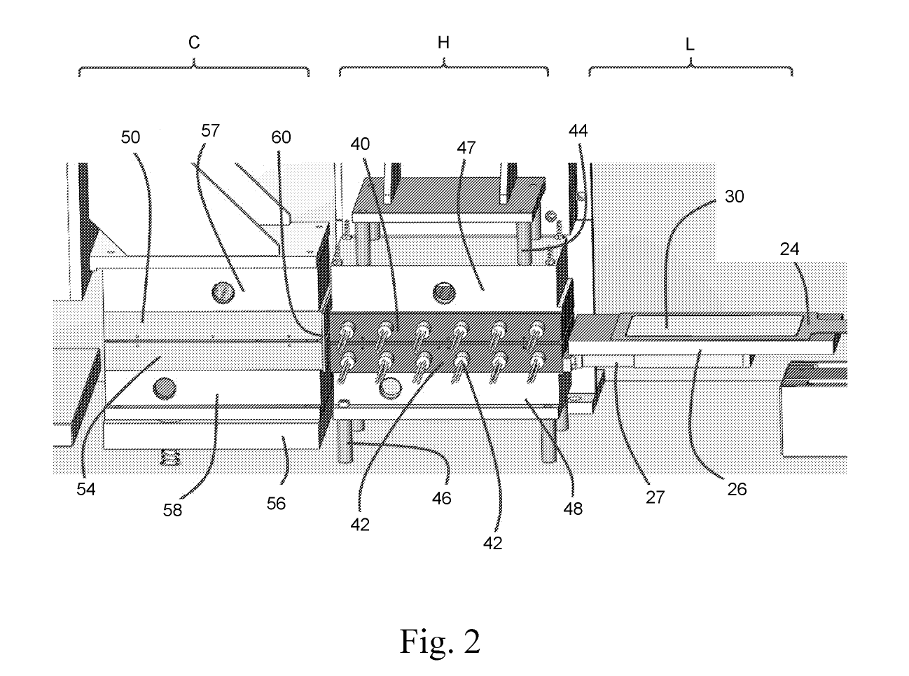

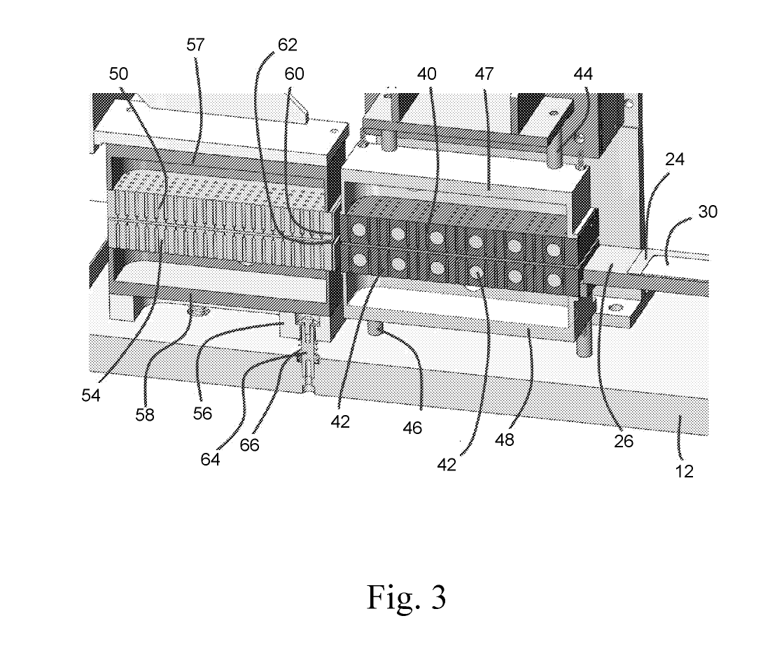

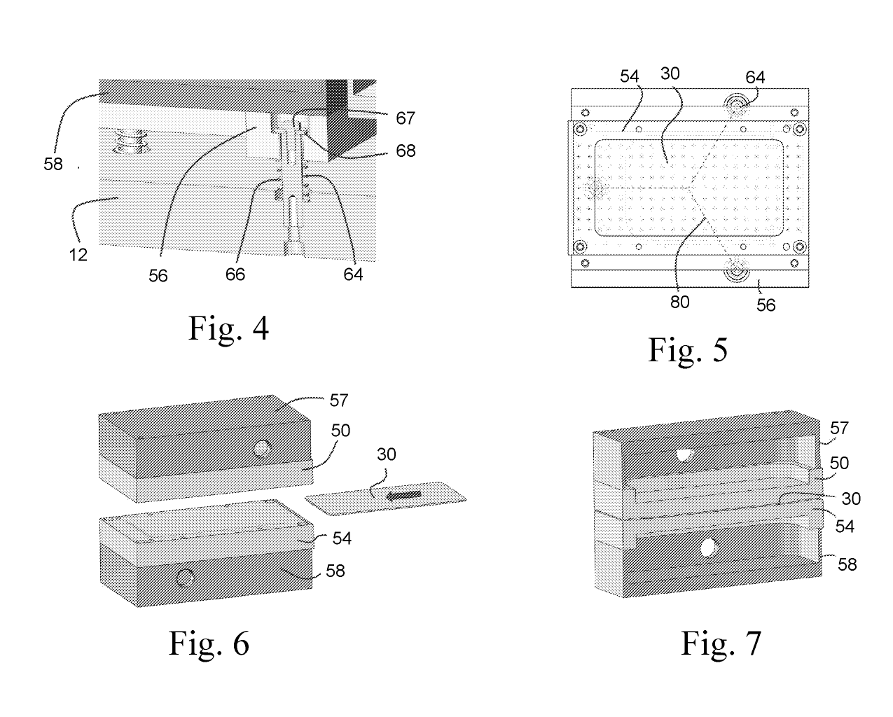

FIG. 1 shows an overall isometric view of a system 10 of the present disclosure. FIG. 2 shows a close-up isometric view of a portion of the system 10. FIG. 3 shows a close-up cross-sectional isometric view of a portion of the system 10. FIG. 4 shows a close-up of the cold mount and related structure.

Referring to FIGS. 1-3, the system is supported on a base plate 12. A conveyor, in the form of a conveyance carriage 20 connected to and moved by a conveyance actuator 22 powered by a motor 23 used to actuate a conveyance frame 24, moves a glass article 30 from a load zone L, to a hot zone H, to a cold zone C (generally identifiable as those parts of the system vertically above the indicated brackets in the figure).

The load zone L includes a loading plate 26 where the glass sheet or article 30 to be processed may be placed.

The hot zone H includes an upper hot fluid bearing 40 and a lower hot fluid bearing 42, mounted on respective top and bottom standoffs 44, 46 for thermal isolation, and fed by respective upper and lower hot plenums 47, 48. The upper hot fluid bearing 40, through the upper standoffs 44, is mounted on a hot zone carriage 42 that allows the vertical position of the bearing 40 to be controlled with precision.

The cold zone C includes an upper cold fluid bearing 50 supported on a cold zone carriage 52 and a lower cold fluid bearing 54 supported on a cold mount 56, each fed by respective upper and lower cold plenums 57, 58. The upper cold fluid bearing 50 is on a cold zone carriage 52, in this embodiment actuated by a cold zone ballscrew actuator 54, which allows its vertical position to be controlled with precision.

The fluid bearings used in embodiments may be of a discrete-hole type, with or without added compensation restrictors, or they may be a solid porous media type. The gaps between the two pairs of fluid bearings (hot and cold) can be equal or different, and they are independently changeable either during set-up or during processing of the glass sheet or article 30. For example, the glass may be conveyed into a zone (whether hot or cold) and then the gaps may be opened or closed—or at a prescribed rate to achieve a desirable heat transfer profile in time. The gaps may also be closed and/or opened in more complex ways. For example, the cold zone gaps may also be quickly closed, then quickly opened to relatively decrease the quenching (cooling) rate in the later part of the quenching time.

During quenching (cooling) in the cold zone, the cold zone fluid bearing surfaces are desirably moved sufficiently close toward the glass article such that, at some point in time during the quenching (cooling), more than 20, 30, 40, 50, or even more than 60 or 70% of said cooling, takes place by conduction from the glass article to the fluid bearing surfaces.

Similarly, during heating in the hot zone, the hot zone fluid bearing surfaces can be moved sufficiently close toward the glass article such that, at some point in time during the heating, more than 20, 30, 40, 50, or even more than 60 or 70% of said heating, takes place by conduction from the glass article to the fluid bearing surfaces. As one alternative method, the hot zone bearings may be closed to a small gap matching (or even being somewhat smaller than) an already small gap in the cold zone bearings before the glass sheet or article is conveyed into the cold zone, such that the cold zone bearings do not need to have very quick actuation capability.

The glass sheet or article 30 can be conveyed from one pair of bearings to the next in order to cause a change in its temperature at a desired rate of heat transfer. In various embodiments, the glass sheet can be conveyed from one zone to the next at a speed that may be desirable to create favorable thermal conditions for processing the glass sheet or glass article: (a) at a speed that is so great that the change in temperature state of the sheet or article during the transition is negligible compared to its change in temperature state once it is fully within in the next zone, or (b) at a speed that is slow such that there is a distinct difference in the temperature state of the sheet or article corresponding to where it is located in the system, or (c) at any desirable speed in between these two extreme conditions. For example, in the case of higher speed transition to the cooling zone, the glass sheet or article changes in temperature, during transition to a point fully within the cooling zone, by less than 100, 80, 60, 50, 40, 30, 20, 10, or even 5° C. or less (but typically equal to or greater than 1° C.), and/or a maximum temperature variation along the surface of the glass sheet in the direction of travel during transition to a point fully within the cooling zone may be less than 30, 20, 10, or even 5° C. or less (but typically equal to or greater than 1° C.). As a further example, in the case of lower speed transition into the cold zone, a maximum temperature variation along the surface of the glass sheet in the direction of travel during transition to a point fully within the cooling zone may be greater than 30, 40, 50, 60, 80, or even 100° C. or more (but typically less than 400° C.).

Referring specifically to FIGS. 2 and 3, a shield 60 with a gap or pass through 62 therein may be positioned between the hot and cold bearings to help preserve the temperature control of both. The loading plate 26 may be supported on a loading plate mount 27. The hot upper and lower hot bearings 40, 42 may comprise cartridge heaters 41 for heating the bearings 40, 42 to desired temperatures. The cold mount 56 may be connected to the baseplate 12 on a sliding shaft 64 and supported by a coil spring 66. As alternative features useful with all embodiments herein, controlled force sources other than springs may be used, to mount and assist in controlling one or both sides of the cold zone bearings (as well as one or both sides of the hot zone bearings, if desired). For instance, electronic controlled force actuators, pneumatic actuators, or the like may be used instead of spring pre-load. Further, the applied force for the bearing preload may be controlled, designed, or otherwise set to be higher than the bearing forces at the gap resulting from position control alone, allowing the gap size to be determined by position control. Alternatively, the bearing preload forces may be controlled, designed or otherwise set to be lower than the gap resulting from position control alone, such that the bearing forces produced by the fluid bearings themselves, balanced against the preload forces, determine the gap size.

According to embodiments, conduction across a very narrow gap filled with a fluid is used, with the fluid typically (but not necessarily) a gas, to chill hot glass sheets very rapidly, as shown in the diagram of FIG. 9. The conduction component of the cooling rate is determined by the thermal conductivity of the fluid in the gap, the size of the gap, and the temperatures of the glass and the bearings:

$${Q}_{conduction} = {A}_{g} ( {T}_{g} - {T}_{b} ) \frac{k}{g}$$

Where Ag is the projected area of the glass part and k is the thermal conductivity of the gas in the gap. Since most fluids have a temperature dependent thermal conductivity, a more general relation is:

$${Q}_{conduction} = \frac{{A}_{g}}{g} {\int }_{{T}_{g}}^{{T}_{b}} k ( T ) dT$$

Shown below in Table 1 are the thermal conductivities as a function of temperature for some common gases.

TABLE 1

| Temp. | | | | | | | | | | | |
|---|---|---|---|---|---|---|---|---|---|---|---|
| ° C. | Air | N2 | Ar | CO2 | He | H2 | O2 | Steam@1 atm | Na | Methane | Propane |
| 27 | 0.0267 | 0.0267 | 0.0176 | 0.0181 | 0.149 | 0.198 | 0.0274 | | 0.0539 | 0.0341 | 0.0202 |
| 127 | 0.0331 | 0.0326 | 0.0223 | 0.0259 | 0.178 | 0.227 | 0.0348 | 0.0277 | 0.0618 | 0.0491 | 0.0306 |
| 227 | 0.0389 | 0.0383 | 0.0265 | 0.0333 | 0.205 | 0.259 | 0.042 | 0.0365 | 0.0697 | 0.0665 | 0.0455 |
| 327 | 0.0447 | 0.044 | 0.0302 | 0.0407 | 0.229 | 0.299 | 0.049 | 0.046 | 0.0775 | 0.0841 | 0.0619 |
| 527 | 0.0559 | 0.055 | 0.0369 | 0.0544 | 0.273 | 0.365 | 0.062 | 0.066 | 0.0933 | 0.1193 | 0.0947 |
| 727 | 0.0672 | 0.066 | 0.0427 | 0.0665 | 0.318 | 0.423 | 0.074 | 0.088 | 0.1090 | 0.1545 | 0.1275 |

Since the thermal conductivity of most gases is very linear with temperature, a very good approximation is to use the conductivity of the gas evaluated at the average temperature (T_{b}+T_{g})/2. For processing of some common glass compositions, this average temperature is approximately 377° C. Shown below in Table 2 is the average thermal conductivity evaluated at this temperature as well as a comparison to the rate of conduction that can be achieved using air.

TABLE 2

| | Air | N2 | Ar | CO2 | He | H2 | O2 | Steam@1 atm | Na | Methane | Propane |
|---|---|---|---|---|---|---|---|---|---|---|---|
| Evaluated at average | 0.0470 | 0.0454 | 0.0302 | 0.0423 | 0.2335 | 0.3105 | 0.0507 | 0.0440 | 0.0815 | 0.0943 | 0.0739 |
| gap temperature of | | | | | | | | | | | |
| 377° C.: | | | | | | | | | | | |
| Ratio to Air: | 1.00 | 0.98 | 0.66 | 0.92 | 5.02 | 6.60 | 1.09 | 1.07 | 1.72 | 1.97 | 1.50 |

As may be appreciated from the foregoing, there is naturally a strong desire to use helium or hydrogen for their high thermal conductivity. Since helium is inert and non-combustible, it is a very desirable gas for this process. However, it is expensive. There is therefore a desire to design the equipment to minimize the use of the high conductivity gas. The present invention is particularly advantageous because the conduction term is independent of the flow rate of fluid in the gap; only enough gas is needed to properly float and center the glass sheet with sufficient accuracy to achieve the desired uniformity of heat transfer on each of the two opposing surfaces. In this way, the use of expensive helium can be minimized

The apparatus of the present disclosure enables dynamic adjustment of the cold zone and hot zone bearing gaps.

Dynamic carriage motion of the cold zone top bearing enables: (1) The gaps (and thus the cooling rate) can be precisely adjusted to achieve the process conditions create desired glass properties. Feedback from the measured glass characteristics (for example, surface compressive stress measurement) can be fed back to the tempering machine for adjustment. (2) Set up for processing different glass thicknesses can be very rapid. Also, if the incoming thickness of the glass varies, that measurement of glass thickness can be fed forward to the machine to compensate. (3) In the event of glass breakage, the bearings can be quickly and easily opened for cleaning and then quickly set back to running conditions. (4) Very rapid and precise carriage motions made after the glass is in the cold bearing gaps can be used to create complex and desirable cooling recipes. Instead of just a fixed heat transfer coefficient, a variable cooling rate can be achieved in the fraction of a second that it takes to get the glass from its initial process temperature (that of the hot zone) down to a temperature in which the tempering stresses are essentially complete.

Dynamic motion of the upper and lower hot zone bearing enables: (1) The gaps can be adjusted rapidly for different glass thicknesses. (2) By setting the gap initially high, the glass can be brought into the hot zone with a shape error (e.g., out of flatness) that is relatively high without scratching the glass. As the glass heats up and softens, the gaps can be reduced, creating a stiffer fluid bearing that tends to improve its shape error (e.g., flatten the glass) prior to sending it to the cold end quench bearings which are typically at a tighter gap. (3) In the event of glass breakage, the bearings can be quickly and easily opened for cleaning and then quickly set back to running conditions.

Solid Contact Mode

FIG. 4 shows a close-up cross-sectional isometric view of one of the sliding shaft assemblies. FIG. 5 shows a top orthographic view with hidden lines of the bottom cold bearing and mount. As shown, the bottom bearing is designed to move vertically if the top bearing is driven down to close the gaps between the cold bearings and the glass article. Coil springs provide preload force to keep the bottom bearings in its home position.

Once driven down past its home position, the coil springs provide a nearly constant prescribed preload force that is imparted to the glass. The three sliding shafts are positioned such that 120 degree reference lines drawn from their centers intersection at a point that is precisely the center of the glass part, thereby providing maximum uniformity of process compression force. For contact quenching, the “bearings” in this can be made from a solid material (no gas pass through). However, fluid bearings (hydrostatic fluid bearings with fluid delivered through the bearing surfaces such as the bearings described above) are currently believed most desirable because the fluid bearings can maintain equal spacing from both bearing surfaces to the surfaces of the glass article or sheet during the approach to contact. Possible contact materials include metals, graphite, etc. They may be coated with a layer of material that has a lower conductivity, thereby reducing the quenching heat transfer rate to a value that is desirable for favorable process conditions. The base materials and/or the coatings may be somewhat soft to add some compliance that enables the contact heat transfer to be more uniform. Grafoil® flexible graphite material (Graftech Inc., Cleveland Ohio USA) has been used with good results.

3D Forming Mode

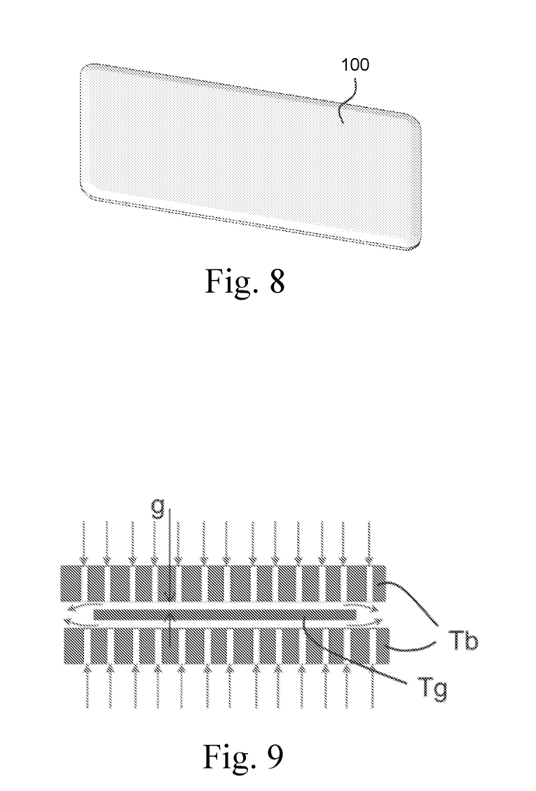

FIG. 6 shows a top orthographic view of a flat glass preform being conveyed into the cold zone, where the top and bottom gas bearings have a defined concave and convex, mating three-dimensional shape to be imparted into the glass article. FIG. 7 shows an orthographic cross-sectional view of a glass article that has been formed into a three-dimensional shape by mating top and bottom cold gas bearings. FIG. 8 shows a orthographic view of a glass article that has been formed with three-dimensional shape using the method of the present invention. In this embodiment, the bearings may preferably be made from a highly restrictive (low gas permeability) porous solid (such as porous graphite) that can generate high stiffness at tight gaps, such that the forming can be done without contact with the glass article. An added advantage of using porous graphite is that, if light contact with the part does occur in some regions, the surface damage imparted to the glass article would be minimized.

In its most general sense, the present apparatuses and methods of the present disclosure enable a glass sheet to be thermally processed with rates of heat transfer (heating or cooling) that higher, more uniform, more deterministic, and more controllable than can be achieved by immersion into a fluid bath or jetted with a fluid.

Thermal processing can occur without contact with the sheet and yet constraining the sheet into a desired shape by the stiffness of the centering action of the fluid bearings.

Even thin very glass can be strengthened by the apparatus and methods disclosed herein. Compared to standard thermal tempering methods, a higher rate of cooling is producible, thereby enabling a higher degree of thermal tempering. A higher degree of uniformity of tempering is also producible than can be achieved with convective jetted air cooling as used for most conventional glass tempering.

In the case of contact quenching, the present methods and apparatuses enable the parts to be cooled with maximum contact uniformity, thereby producing tempered glass articles with the highest degree of uniformity that can be achieved using contact quenching.

In the case of three-dimensional molding of a glass preform, the present methods and apparatuses have the following advantages compared to all prior methods which have used hot molds: (1) Since the molds are cold, the mold material will not be subject to dramatic oxidation or other material stability issues, thereby opening up the possibility of using other mold materials such as carbon graphite. (2) Since the molds are cold, a higher level of precision can be maintained in the mold geometry itself. (3) Since the molds are cold, lateral alignment of the top mold to the bottom is dramatically simplified. Higher alignment precision enables a more robust process and parts with minimal amount of form error. (4) Since the molds are cold, the interaction of mold surface and the glass can be minimized, which can significantly improve mold life. (5) Since the molding and the quenching step of the thermal tempering is accomplished in one step which takes only seconds, this embodiment or aspect of the disclosed methods enables economic benefits and the possibility of high volume production.

Product Shapes

Because the cold zone bearing surfaces can be made in shapes which are not only not flat, but also shapes which are neither a portion of a cylindrical surface nor a portion of a toroidal surface, when glass sheets are processes according to the present methods and apparatuses, highly strengthened sheets having more versatile shapes can be produced. For instance, qualities of flatness and smoothness similar to those disclosed in WO20170200441A1 can be obtained, but on sheets having curved surfaces which are neither sections of a cylindrical surface nor sections of a toroidal surface, to which the process and apparatus of WO20170200441A1 is limited.

Accordingly, a product in the form of a strengthened glass article or sheet is producible having a first major surface, a second major surface opposite the first major surface and separated from the first major surface by a thickness t and an interior region located between the first and second major surfaces. An outer edge surface extends between and surrounds the first and second major surfaces such that the outer edge surface defines a perimeter of the article. The article is thermally tempered such that at the first major surface is under compressive stress. The strengthened glass article comprises a glass material having a low temperature linear CTE, when expressed in 1/° C., of α^{S}_{CTE}, a high temperature linear CTE, when expressed in 1/° C., of α^{L}_{CTE}, an elastic modulus, when expressed in GPa, of E, a strain temperature, when expressed in units of ° C., of Tₛₜᵣₐᵢₙ, and a softening temperature, when expressed in units of ° C., of T_{soft}, with the foregoing variable being unitless in the following expressions:

The compressive stress of the first major surface is less than 600 MPa and greater than

$$\frac{{P}_{1} ( h ) * t}{( {P}_{2} ( h ) * t )} \cdot E \cdot [ {T}_{strain} \cdot {α}_{CTE}^{s} + {α}_{CTE}^{L} \cdot ( {T}_{soft} - {T}_{strain} ) ] ;$$

in units of MPa;

when P₁ is given by

$$910.2 - 259.2 \cdot exp ( - \frac{h}{0.143} ) ;$$

P₂ is given by

$$2.53 + \frac{23.65}{( 1 + {( \frac{h}{0.00738} )}^{1.58} )} ;$$

and h is greater than or equal to 0.020 and wherein at least the first major surface is a curved surface other than a portion of a cylindrical surface and other than a portion of a torroidal surface.

The strengthened glass article or sheet can have strengths wherein h is between 0.020 and 0.030, wherein h is greater than or equal to 0.024, wherein h is greater than or equal to 0.028, or even higher.

The strengthened glass article or sheet can have a low surface roughness of the first major surface between 0.2 and 1.5 nm Ra roughness.

The strengthened glass article or sheet can additionally have a low a surface roughness of the second major surface is between 0.2 and 1.5 nm Ra roughness.

The strengthened glass article or sheet can also have good flatness, wherein the first and second major surfaces are flat to within at least 50 μm total indicator run-out (TIR) along a 50 mm profile of the first and second major surfaces.

Movement Speed

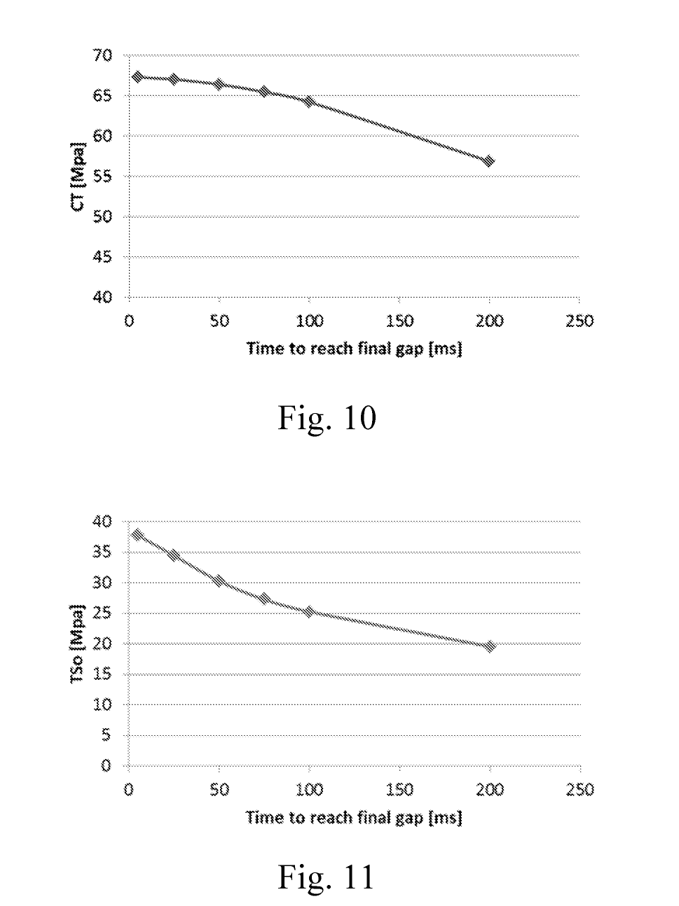

FIG. 10 is a graph output from a simulation of thermal tempering of glass showing central tension as a function of time to reach final gap size in the cold zone of an embodiment of the present invention. FIG. 11 is a graph output from a simulation of thermal tempering of glass showing maximum transient surface tension (occurring during cooling at any time) as a function of time to reach final gap size in the cold zone of an embodiment of the present invention. In each case, the glass simulated was 1.08 mm thick soda lime with an initial temperature of 670° C. The initial gap size as simulated (before movement of one or both of the two cold zone fluid bearing surfaces) was 393 μm (on each side of the glass between the glass surface and the respective bearing face), while the final gap size was 93 μm.

As may be appreciated from the FIG. 10, fast transition speeds (below 200 ms, desirably below 100 and even below 50 ms) are desirable to achieve the highest stress and associated strengthening levels. Accordingly, it is desirable to use actuators capable of achieving these response times. On the other hand, for the simulated glass thickness, initial temperature, and at the simulated gaps, transition speeds below 50 ms result in little increase in the final central tension (CT) stress (FIG. 10) but in a still significant increase in the maximum transient surface tension (TSo) (FIG. 11). Accordingly, it is desirable to move the one or both of the two cold zone fluid bearing surfaces toward the glass article or sheet sufficiently fast to obtain around 95%, or within 95% to 97%, but not more, of the theoretically available final resulting central tension (CT), but not more. Limiting the move speed in this way effectively reduces the corresponding maximum transient surface stress seen by the glass by as much as 20-30% or more.

Other aspects and advantages will be apparent from a review of the specification as a whole.

The construction and arrangements of the materials and structures, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, orientations) without materially departing from the novel teachings and advantages of the subject matter described herein. For example, both flat and curved glass articles may be tempered according to the methods described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present inventive technology.

1. A process for thermally strengthening a glass article, the process comprising
first conveying a glass article, the article having a temperature above a transition point of the glass of the article, into position between a first two fluid bearing surfaces;
second moving one or both of the first two fluid bearing surfaces toward the glass article and cooling the glass article, with at least 20% of said cooling taking place by conduction, from the glass article to the fluid bearing surfaces, during at least some point in time during the cooling.

2. The process according to claim 1 wherein at least 30% of said cooling takes place by conduction from the glass article to the fluid bearing surfaces.

3. The process according to claim 1 wherein at least 40% of said cooling takes place by conduction from the glass article to the fluid bearing surfaces.

4. The process according to claim 1 wherein at least 50% of said cooling takes place by conduction from the glass article to the fluid bearing surfaces.

5. The process according to claim 1 wherein the conduction takes place from the glass article through a fluid of the fluid bearing to the fluid bearing surfaces.

6. The process according to claim 1 wherein the conduction takes place at least in part from the glass article through directly to the fluid bearing surfaces without conduction through a fluid of the fluid bearing.

7. The process according to claim 1 further comprising the step of heating the glass article before conveying the glass article, wherein the step of heating is performed with the article positioned between a second two fluid bearing surfaces.

8. The process according to claim 7 wherein the step of heating the glass article further comprises moving one or both of the second two fluid bearing surfaces toward the glass article.

9. The process according to claim 1 wherein the step of conveying comprises transitioning the article to a point fully within the cooling zone sufficiently quickly such that the glass article changes in temperature, during transition to a position fully within the cooling zone, by less than 50° C.

10. The process according to claim 1 wherein the step of conveying comprises transitioning the article to a point fully within the cooling zone sufficiently quickly such that the glass article changes in temperature, during transition to a position fully within the cooling zone, by less than 20° C.

11. The process according to claim 1 wherein the step of conveying comprises transitioning the article to a point fully within the cooling zone sufficiently quickly such that the glass article changes in temperature, during transition to a position fully within the cooling zone, by less than 10° C.

12. The process according to claim 1 wherein the step of conveying comprises transitioning the article to a point fully within the cooling zone sufficiently quickly such that the glass article changes in temperature, during transition to a position fully within the cooling zone, by less than 5° C.

13. The process according to claim 1 wherein the step conveying comprises transitioning the article to a point fully within the cooling zone sufficiently quickly such that of a maximum temperature variation along the surface of the glass sheet in the direction of travel is less than 30° C.

14. The process according to claim 1 wherein the step conveying comprises transitioning the article to a point fully within the cooling zone sufficiently quickly such that of a maximum temperature variation along the surface of the glass sheet in the direction of travel is less than 10° C.

15. The process according to claim 1 wherein the step conveying comprises transitioning the article to a point fully within the cooling zone sufficiently quickly such that of a maximum temperature variation along the surface of the glass sheet in the direction of travel is less than 5° C.

16. The process according to claim 1 wherein the first two bearing surfaces have a surface shape other than planar.

17. The process according to claim 1 wherein the first two bearing surfaces have a curved surface shape other than a section of a cylindrical surface and other than a section of a toroidal surface.

18. The process according to claim 1 wherein the step of moving one or both of the first two fluid bearing surfaces toward the glass article comprises moving one or both of the first two fluid bearing surfaces toward the glass article until one or both of the first two fluid bearing surfaces contact the glass article.

19. The process according to claim 1 wherein the step of moving one or both of the first two fluid bearing surfaces toward the glass article is performed such that the first two fluid bearing surfaces do not contact the glass article during said step.

20. The process according to claim 1 wherein the first two fluid bearing surfaces comprise surfaces of gas bearings.

21. The process according to claim 1 wherein the first two fluid bearing surfaces comprise surfaces of liquid bearings.

22. The process according to claim 1 wherein the glass article is a sheet.

23. A process for thermally strengthening a glass article, the process comprising
first, heating a glass article positioned in a hot zone between two hot zone fluid bearing surfaces while moving one or both of the two hot zone fluid bearing surfaces toward the glass article without contacting the glass article, said heating to a temperature above a transition point of a glass of the article with at least 20% of said heating taking place by conduction during at least some point in time during said heating;
second, conveying the glass article into position in a cold zone between a two cold zone fluid bearing surfaces.

24. The process according to claim 23, further comprising the step of: third, moving one or both of the two cold zone fluid bearing surfaces toward the glass article and cooling the glass article, with at least 20% of said cooling taking place by conduction, from the glass article to the fluid bearing surfaces, during at least some point in time during the cooling.

25. The process of claim 23, wherein the step of first, heating a glass article further comprises moving one or both of the two hot zone fluid bearing surfaces toward the glass article until a gap between the two hot zone fluid bearing surfaces matches a gap between the two cold zone bearing surfaces matching or being small than a gap between the two cold zone fluid bearing surfaces.

26. An apparatus for thermal tempering of glass, the apparatus comprising:
a cold zone comprising two cold zone fluid bearing surfaces, one or both of the cold zone fluid bearing surfaces being moveable, under automated control, toward and away from the other of the two cold zone fluid bearing surfaces so as automatically vary a gap between the two cold zone fluid bearing surfaces; and
a conveyor moveable under automated control between the hot zone and the cold zone so as to be capable to move a glass article under treatment from the hot zone to the cold zone;
wherein the moveable cold zone fluid bearing surface(s) and the moveable conveyor are moveable independently and wherein the automated control of the moveable cold zone fluid bearing surface(s) is programmed and/or designed so as to move the moveable cold zone fluid bearing surface(s) during processing of a glass article.

27. The apparatus of claim 26 further comprising:
a hot zone comprising two hot zone fluid bearing surfaces, one or both of the hot zone fluid bearing surfaces being moveable, under automated control, toward and away from other of the two hot zone fluid bearing surfaces so as automatically vary a gap between the two hot zone fluid bearing surfaces, and
wherein the moveable hot zone fluid bearing surface(s) and the moveable conveyor are moveable independently and wherein the automated control of the moveable hot zone fluid bearing surface(s) is programmed and/or designed so as to move the moveable hot zone fluid bearing surface(s) during processing of a glass article.

28. The apparatus of claim 26 wherein one or both of the cold zone fluid bearing surfaces is supported on or by a controlled force actuator.

29. The apparatus of claim 28 wherein the controlled force actuator comprises one spring or multiple springs.

30. A strengthened glass article comprising:
a first major surface;
a second major surface opposite the first major surface and separated from the first major surface by a thickness t;
an interior region located between the first and second major surfaces; and
an outer edge surface extending between and surrounding the first and second major surfaces such that the outer edge surface defines a perimeter of the article;
wherein the article is thermally tempered such that at the first major surface is under compressive stress;
the strengthened glass article comprising a glass material having a low temperature linear CTE, expressed in 1/° C., of α^{S}_{CTE}, a high temperature linear CTE, expressed in 1/° C., of α^{L}_{CTE}, an elastic modulus, expressed in GPa, of E, a strain temperature, expressed in units of ° C., of Tₛₜᵣₐᵢₙ, and a softening temperature, expressed in units of ° C., of T_{soft};
the compressive stress of the first major surface is less than 600 MPa and greater than
$$\frac{{P}_{1} ( h ) * t}{( {P}_{2} ( h ) * t )} \cdot E \cdot [ {T}_{strain} \cdot {α}_{CTE}^{s} + {α}_{CTE}^{L} \cdot ( {T}_{soft} - {T}_{strain} ) ] ;$$
in units of MPa;
wherein P₁ is given by
$$910.2 - 259.2 \cdot exp ( - \frac{h}{0.143} ) ;$$
P₂ is given by
$$2.53 + \frac{23.65}{( 1 + {( \frac{h}{0.00738} )}^{1.58} )} ;$$
and h is greater than or equal to 0.020;
wherein at least the first major surface is a curved surface other than a portion of a cylindrical surface and other than a portion of a toroidal surface.
